(19) United States
(12) Patent Application Publication
(10) Pub. No.: US 2018/0012701 A1
(43) Pub. Date: Jan. 11, 2018

(54) METHOD FOR PRODUCING RFeB SYSTEM SINTERED MAGNET

(71) Applicant: INTERMETALLICS CO., LTD., Nakatsugawa-shi, Gifu (JP)

(72) Inventors: Masato SAGAWA, Kyoto-shi (JP); Yasuhiro UNE, Nagoya-shi (JP); Hirokazu KUBO, Kasugai-shi (JP); Satoshi SUGIMOTO, Sendai-shi (JP); Masashi MATSUURA, Sendai-shi (JP); Michihide NAKAMURA, Nagoya-shi (JP)

(73) Assignee: INTERMETALLICS CO., LTD., Nakatsugawa-shi, Gifu (JP)

(21) Appl. No.: 15/539,585

(22) PCT Filed: Jan. 8, 2016
(86) PCT No.: PCT/JP2016/050443

§ 371 Date: Jun. 23, 2017

(30) Foreign Application Priority Data
Jan. 9, 2015 (JP) 2015-003650

(51) Int. Cl. H01F 41/02; C22C 38/00; B22F 9/04; B22F 3/10; C22C 38/16; C22C 38/10; C22C 38/06; H01F 1/053; C22C 28/00

(52) U.S. Cl. CPC H01F 41/0266; H01F 1/0536; C22C 38/005; B22F 9/04; C22C 28/00; C22C 38/16; C22C 38/10; C22C 38/06; B22F 3/10; B22F 2202/05; B22F 2009/044; C22C 2202/02

(57) ABSTRACT

A method for producing an RFeB system sintered magnet according to the present invention includes: a process (S1) of preparing a lump of HDDR-treated raw material alloy that contains a polycrystalline substance including crystal grains having an average grain size of 1 μm or less in terms of an equivalent circle diameter calculated from an electron micrograph image, by an HDDR treatment including steps of heating a lump of RFeB system alloy containing 26.5 to 29.5% by weight of the rare-earth element R, in a hydrogen atmosphere at a temperature between 700 and 1,000° C., and changing the atmosphere to vacuum while maintaining the temperature within a range from 750 to 900° C.; a process (S2) of preparing a lump of raw material alloy having a high rare-earth content by heating the lump of HDDR-treated raw material alloy at a temperature between 700 and 950° C. in a state where the HDDR-treated raw material alloy is in contact with a contact substance including a second alloy that contains the rare-earth element R at a higher content ratio than a content ratio of the rare-earth element R in the RFeB system alloy; a process (S3) of preparing raw material alloy powder by fine pulverization of the lump of raw material alloy having a high rare-earth content into powder having an average particle size of 1 μm or less; an orienting process (S4) including steps of placing the raw material alloy powder in a mold, and applying a magnetic field to the raw material alloy powder without conducting compression molding; and a sintering process (S5) including a step of heating the oriented raw material alloy powder at a temperature between 850 and 1,050° C.

### TECHNICAL FIELD

The present invention relates to a method for producing an RFeB system sintered magnet containing, as main components, rare-earth elements (R) including yttrium (Y) as well as iron (Fe) and boron (B).

### BACKGROUND ART

An RFeB system sintered magnet is a permanent magnet produced by orienting and sintering powder of an RFeB alloy. RFeB system sintered magnets were discovered by Sagawa et al. in 1982. They have far better magnetic characteristics than those of conventional permanent magnets and have the advantage that they can be produced from rare-earth elements, iron and boron, which are all comparatively abundant and inexpensive materials.

It is expected that RFeB system sintered magnets will be increasingly in demand in the future as permanent magnets for motors to be used in hybrid cars, electric cars, fuel-cell cars, as well as for other applications. Temperatures in motors for automobiles increase, during operation, from ordinary temperatures to about 180° C. In view of this, RFeB system sintered magnets to be used for automobile motors need to be guaranteed to operate under such a temperature range. Therefore, RFeB system sintered magnets which have a high level of coercivity over the entirety of the temperature range are in demand.

Coercivity is a parameter which indicates the intensity of a magnetic field that is required to reduce magnetization to zero when the magnetic field opposite to the direction of magnetization is applied to a magnet. The higher coercivity is, the more resistant the magnet is to the opposite magnetic field. Typically, the coercivity decreases with an increase in the temperature. Accordingly, a magnet having a higher level of coercivity at ordinary temperatures (i.e., at room temperature) also has a higher level of coercivity at high temperatures. In view of the above, various efforts have been conducted to increase, as one index, the value of the coercivity at ordinary temperatures. Hereinafter, when the “coercivity” is simply used, the coercivity at ordinary temperatures is intended.

For NdFeB system sintered magnets which contains neodymium (Nd) as the rare earth R, the method of partially substituting dysprosium (Dy) and/or terbium (Tb) (which are hereinafter represented by R^{H}) for Nd in the magnet has conventionally been adopted to increase the coercivity. However, R^{H} are extremely rare elements, and furthermore, their production sites are considerably localized. Such a condition allows a producing country to intentionally halt the supply or increase the price, making it difficult to ensure a stable supply. In addition, the substitution of Nd by R^{H} causes a decrease in the residual magnetic flux density, which indicates the magnitude of the magnetization (or magnetic force).

One method for increasing the coercivity of the NdFeB system sintered magnet without using R^{H} is to reduce the size of the individual crystal grains which form the main phase (R₂Fe₁₄B) within the NdFeB system sintered magnet (Non Patent Literature 1). It is commonly known that the coercivity of any kind of ferromagnetic material (or even ferrimagnetic material) can be increased by reducing the size of the internal crystal grains.

A conventional method for reducing the size of the crystal grains within the RFeB system sintered magnet is to reduce the particle size of alloy powder prepared as the raw material for the RFeB system sintered magnet. However, it is difficult to achieve an average particle size that is smaller than 3 μm by jet mill pulverization using nitrogen gas, which is a commonly used method for preparing alloy powder.

One commonly known technique for reducing the crystal grain size is the “HDDR” treatment. In the HDDR treatment, a lump or coarse powder of an R₂Fe₁₄B raw material alloy (such a lump or coarse powder is hereinafter collectively referred to as the “lump of raw material alloy”) is heated in a hydrogen atmosphere at a temperature between 700 and 1,000° C. (“Hydrogenation”) to decompose the R₂Fe₁₄B compound into three phases of RH₂, Fe₂B, and Fe (“Decomposition”). Subsequently, the atmosphere is changed from hydrogen to vacuum, while maintaining the temperature, to desorb hydrogen from the RH₂ phase (“Desorption”), thereby causing a reaction to recombine these phases into the R₂Fe₁₄B compounds (“Recombination”). As a result, crystal grains having an average size of 1 μm or less with a narrow distribution width are formed as a phase of the R₂Fe₁₄B compound inside the lump of raw material alloy.

Patent Literature 1 discloses that a sintered magnet is produced with powder obtained by pulverizing a lump of raw material alloy that has undergone an HDDR treatment, (hereinafter, referred to as “a lump of HDDR-treated raw material alloy”) with a jet mill using nitrogen gas. However, the jet mill pulverization using nitrogen gas cannot pulverize lumps sufficiently, as noted earlier. Accordingly, while the crystal grains contained in each particle of the raw material alloy powder prepared by pulverizing a lump of HDDR-treated raw material alloy have the grain size smaller than that of the conventional grains, the particle size of the raw material alloy powder itself remains as large as that of the conventional powder. Thus, each particle of the raw material alloy powder prepared by the method disclosed in Patent Literature 1 contains a plurality of crystal grains. This prevents the crystal grains from being individually oriented when a magnetic field is applied to the raw material alloy powder in the orienting process. This reduces the residual magnetic flux density of the sintered magnet.

The present inventors have found that treating an alloy lump by a jet mill method using helium gas instead of nitrogen gas (helium jet mill method) allows the lump of raw material alloy to be pulverized into powder having an average particle size of 1 μm or less (submicron size), and have applied this pulverization method to a lump of HDDR-treated raw material alloy (Patent Literature 2). The raw material alloy powder thus obtained includes a high amount of particles each consisting of a single crystal grain. Orienting such raw material alloy powder in a magnetic field allows each of the crystal grains to be easily oriented. This increases the residual magnetic flux density. In addition, the decrease in the grain size of the individual crystal grains increases the coercivity of the magnet, as described earlier.

As another example of the method of improving the coercivity using the HDDR treatment, Patent Literature 3 discloses that: a lump of HDDR-treated NdFeB system alloy is pulverized into powder having an average particle size of about 100 μm to prepare a magnet raw material; fine powder of an alloy containing Nd and copper (Cu) is mixed in the obtained magnet raw material; a magnetic field is applied to the obtained mixture; subsequently, the mixture is heated at 700° C. under the pressure of 2 t/cm² by a hot pressing machine; and thus a molded compact of an NdFeB system magnet is obtained. With this method, a surrounding layer that contains Nd and Cu is formed around each of the Nd₂Fe₁₄B crystal grains. The surrounding layer blocks magnetic interactions between adjacent crystal grains, improving the coercivity. However, this method is not a sintering method and uses a magnet raw material having an average particle size which is by two orders of magnitude larger than the one used in the sintering method. Accordingly, the residual magnetic flux density cannot be enhanced by this method.

### CITATION LIST

### Patent Literature

Patent Literature 1: JP 2010-219499 A
Patent Literature 2: WO 2014/142137 A1
Patent Literature 3: JP 2014-057075 A

### Non Patent Literature

Non Patent Literature 1: Yasuhiro Une and Masato Sagawa, “Enhancement of Coercivity of Nd—Fe—B Sintered Magnets by Grain Size Reduction”, J. Japan Inst. Metals, Vol. 76, No. 1 (2012), pp. 12-16, special issue on “Eikyuu Jishaku Zairyou No Genjou To Shourai Tenbou”

### SUMMARY OF INVENTION

### Technical Problem

The method disclosed in Patent Literature 2 is excellent among the three conventional aforementioned methods in that it can enhance both coercivity and residual magnetic flux density. However, the usage of the RFeB system sintered magnet without R^{H} in automobile motors requires more enhanced coercivity. The present inventors have studied the microstructure of the RFeB system sintered magnet prepared by the method disclosed in Patent Literature 2, and have revealed that the width of an intergranular grain boundary that is the grain boundary between two adjacent crystal grains (hereinafter, referred to as the “grain-boundary width”), is smaller than that of conventional RFeB system sintered magnets. If the grain-boundary width of an intergranular grain boundary is small, a magnetic interaction, called exchange coupling, occurs between adjacent crystal grains. This allows a magnetic domain with inverted magnetization to be easily formed and lower the coercivity.

The present inventors have further studied the reason why the grain-boundary width of an intergranular grain boundary partially decreases by the method disclosed in Patent Literature 2. For the formation of the intergranular grain boundary having a large grain-boundary width, it is preferable that a rare-earth rich phase containing a higher amount of rare-earth elements R than those contained in the R₂Fe₁₄B phase is present as uniformly as possible between the particles of the raw material alloy powder at the stage immediately before sintering. The reason for this condition is described hereinafter.

The rare-earth rich phase has a melting point lower than that of the R₂Fe₁₄B phase. The rare-earth rich phase is melted when heated for the sintering, and penetrates through the particles of the raw material alloy powder. As aforementioned, in the method according to Patent Literature 2, each particle of the raw material alloy powder most likely consists of a single crystal grain. Accordingly, if a state in which the rare-earth rich phase is uniformly present in the powder can be realized, the RFeB system sintered magnet obtained by sintering such raw material alloy powder will have the rare-earth rich phase diffused through the intergranular grain boundaries, and thus have a large grain-boundary width of the intergranular grain boundary. However, the state in which the rare-earth rich phase is uniformly present in the raw material alloy powder has been difficult to realize for the following reasons. A lump of raw material alloy before being treated by the HDDR method is typically prepared by a strip casting method. In the lump of raw material alloy prepared by the method, rare-earth rich phases having a laminar form are formed with a spacing of 3 to 5 μm (this structure is hereinafter called the lamellae structure). The rare-earth rich phase does not sufficiently penetrate in all of the grain boundaries between RFeB system crystal grains produced between the rare-earth rich phases that form the lamellae structure. Thus, it is observed that the rare-earth rich phase is not uniformly diffused. It is also difficult for methods other than the strip casting method to uniformly diffuse the rare-earth rich phase. If such a lump of raw material alloy is treated by the HDDR treatment to prepare a lump of HDDR-treated raw material alloy, and if the obtained lump is pulverized with the helium jet mill method, the obtained raw material alloy powder, will also have a non-uniform distribution of the rare-earth rich phase. In the RFeB system sintered magnet formed by sintering such raw material alloy powder, the rare-earth rich phase is not uniformly diffused in the grain boundaries. Thus, a large grain-boundary width of the intergranular grain boundary is not formed, and the coercivity will be lowered.

The problem to be solved by the present invention is to provide a method for producing an RFeB system sintered magnet with high coercivity achieved by using crystal grains having an average grain size of 1 μm or less and by having the rare-earth rich phase uniformly diffused through the grain boundaries to thereby uniformly form intergranular grain boundaries having a large grain-boundary width.

### Solution to Problem

The present invention developed for solving the previously described problem is a method for producing an RFeB system sintered magnet containing a rare-earth element R, Fe and B as main components, the method including:

a) a process of preparing a lump of HDDR-treated raw material alloy that contains a polycrystalline substance including crystal grains having an average grain size of 1 μm or less in terms of an equivalent circle diameter calculated from an electron micrograph image, by an HDDR treatment including the steps of heating a lump of RFeB system alloy containing 26.5 to 29.5% by weight of the rare-earth element R, in a hydrogen atmosphere at a temperature between 700 and 1,000° C., and changing the atmosphere to vacuum while maintaining the temperature within a range from 750 to 900° C.;

b) a process of preparing a lump of raw material alloy having a high rare-earth content (rare earth grain boundary penetration process) by heating the lump of HDDR-treated raw material alloy at a temperature between 700 and 950° C. in a state where the HDDR-treated raw material alloy is in contact with a contact substance including a second alloy that contains the rare-earth element R at a higher content ratio than a content ratio of the rare-earth element R in the RFeB system alloy;

c) a process of preparing raw material alloy powder by fine pulverization of the lump of raw material alloy having a high rare-earth content into powder having an average particle size of 1 μm or less;

d) an orienting process including the steps of placing the raw material alloy powder in a mold, and applying a magnetic field to the raw material alloy powder without conducting compression molding; and

e) a sintering process including the step of heating the oriented raw material alloy powder at a temperature between 850 and 1,050° C.

According to the present invention, the HDDR treatment is conducted to prepare the lump of HDDR-treated raw material alloy containing a polycrystalline substance including fine crystal grains having an average grain size of 1 μm or less in terms of the equivalent circle diameter, followed by heating the lump at a temperature between 700 and 950° C., with the lump of HDDR-treated raw material being in contact with a contact substance including the second alloy that contains the rare-earth element R at a higher content ratio than that of the rare-earth element R in the RFeB system alloy. With this, the second alloy is melted and uniformly penetrate through the grain boundaries in the lump of HDDR-treated raw material alloy. In the obtained lump of raw material alloy having a high rare-earth content, each of the crystal grains is in contact with the second alloy. Therefore, in a raw material alloy powder obtained by pulverizing such a lump of raw material alloy having a high rare-earth content to an average particle size of 1 μm or less, each particle that is most likely to consist of a single crystal grain as mentioned earlier, has a surface on which the second alloy exists. Heating such raw material alloy powder at a temperature between 900 and 1,000° C. in the sintering step allows the second alloy (rare-earth rich phase) to be melted and diffused over the intergranular grain boundaries. Thus, an RFeB system sintered magnet in which intergranular grain boundaries with the uniform grain-boundary width are formed is obtained. Accordingly, the RFeB system sintered magnet produced according to the present invention contains crystal grains having a small average grain size of 1 μm or less, and also has high coercivity due to the large grain-boundary width of the intergranular grain boundaries.

If the content ratio of the rare-earth element R is lower than 26.5% by weight in the RFeB system alloy lump used as the raw material, the crystal grains in the eventually produced RFeB system sintered magnet will be short of the rare-earth element R. In contrast, if the content ratio of the rare-earth element R is higher than 29.5% by weight in the RFeB system alloy lump, the residual magnetic flux density of the RFeB system sintered magnet decreases. Accordingly, in the present invention, the content ratio of the rare-earth element R in the RFeB system alloy lump is set within a range from 26.5 to 29.5% by weight. The second alloy may be any kind of alloy which melts at a heating temperature in the rare earth grain boundary penetration process, with no specific limitation on the components other than the rare-earth element R.

For the raw material, it is preferable to use the RFeB system alloy lump prepared by the strip casting method (despite the aforementioned problem of the lamellae structure), since this method allows for an increase in the uniformity in diffusion of the rare-earth rich phase in comparison with other methods.

For the contact substance including the second alloy, it is preferable to use a powdery contact substance for easy contact with the lump of HDDR-treated raw material alloy.

It is preferable to use the jet mill method using helium gas for the fine pulverization of the coarse particles having a high rare-earth content into powder having the average particle size of 1 μm or less.

### Advantageous Effects of the Invention

According to the present invention, it is possible to produce an RFeB system sintered magnet with high coercivity achieved by using crystal grains having an average grain size of 1 μm or less and by having the rare-earth rich phase uniformly diffused through the grain boundaries to thereby uniformly form intergranular grain boundaries having a large grain-boundary width.

The high coercivity achieved by the present invention eliminates the need of using expensive and rare R^{H}. Alternatively, an RFeB system sintered magnet having an even higher level of coercivity can also be obtained by using R^{H} as a portion or the entirety of the rare-earth element R.

### BRIEF DESCRIPTION OF DRAWINGS

FIG. 1A is a flow chart showing processes of a method for producing an RFeB system sintered magnet according to examples of the present invention. FIG. 1B is a flow chart showing processes in Comparative Examples.

FIG. 2 is a graph showing a temperature history and a gas atmosphere during an HDDR treatment in the examples.

FIGS. 3A and 3B are backscattered electron images taken with an electron microscope, where FIG. 3A shows a lump of material alloy having a high rare-earth content prepared in one stage of a method for producing the RFeB system sintered magnet according to Example 2, and FIG. 3B shows the lump of HDDR-treated raw material alloy prepared in the previous stage.

FIGS. 4A and 4B are backscattered electron images showing a lump of HDDR-treated raw material alloy observed with an electron microscope, prepared in one stage of a method for producing an RFeB system sintered magnet according to Comparative Examples 1 and 2, respectively.

### DESCRIPTION OF EMBODIMENTS

Examples of the method for producing an RFeB system sintered magnet according to the present invention are hereinafter described with reference to the drawings. It should be noted that the present invention is not limited to the following examples.

### Method for Producing RFeB System Sintered Magnet According to Example 1

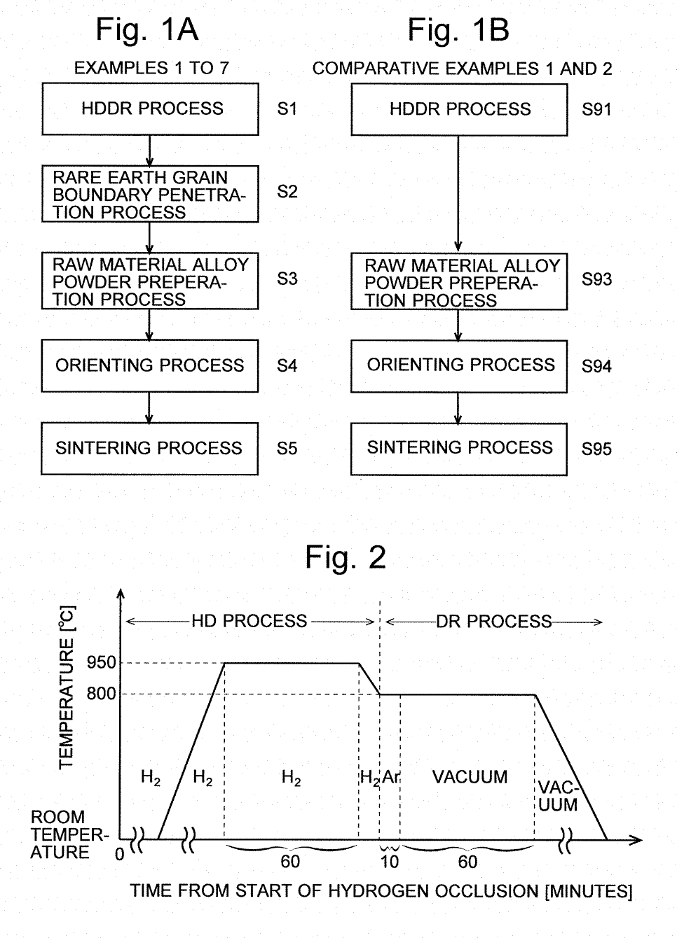

In Example 1, an RFeB system sintered magnet was produced using, as materials, a lump of RFeB system alloy and powder of a second alloy having the compositions shown in Table 1 below, by five processes as shown in FIG. 1A: the HDDR process (Step S1), rare earth grain boundary penetration process (Step S2), raw material alloy powder preparation process (Step S3), orienting process (Step S4), and sintering process (Step S5). In Table 1, “TRE” indicates the total content by percentage of the rare-earth elements (Nd and praseodymium (Pr) in Example 1) contained in the lump of RFeB system alloy.

TABLE 1
Composition of materials used in Example 1 (unit: % by weight)

| | TRE | Nd | Pr | B | Cu | Al | Co | Fe |
|---|---|---|---|---|---|---|---|---|
| RFeB system | 28.1 | 24.33 | 3.76 | 1.00 | 0.00 | 0.04 | 0.95 | bal. |
| alloy lump | | | | | | | | |
| Second alloy | 80.0 | 80.0 | 0.00 | 0.00 | 10.0 | 10.0 | 0.00 | 0.00 |
| powder | | | | | | | | |

The HDDR process is described with reference to the graph shown in FIG. 2. First, a lump of RFeB system alloy that had been prepared by a strip casting method, and had an equivalent circle diameter ranging from 100 μm to 20 mm was prepared. The lump of RFeB system alloy was made to occlude hydrogen sufficiently at room temperature, and then heated at 950° C. for 60 minutes in a hydrogen atmosphere of 100 kPa to decompose the Nd₂Fe₁₄B compound (main phase) in the lump of HDDR-treated raw material alloy into three phases of NdH₂ phase, Fe₂B phase, and Fe phase (Decomposition: “HD process” in FIG. 2). Next, with the hydrogen atmosphere being maintained, the temperature was decreased to 800° C., and then argon (Ar) gas was supplied for 10 minutes, with the temperature being maintained at 800° C., to remove hydrogen gas surrounding the lump of RFeB system alloy. Subsequently, the atmosphere was changed to vacuum, and the temperature was maintained at 800° C. for 60 minutes to desorb the hydrogen atoms in the form of gas from the NdH₂ phase in the lump of RFeB system alloy so as to cause a recombination reaction of the Fe₂B phase and the Fe phase (Desorption and Recombination: “DR process” in FIG. 2). After that, the temperature was decreased to room temperature by cooling the furnace. The lump of HDDR-treated raw material alloy was thus prepared. It should be noted that the purpose of decreasing the temperature from 950° C. to 800° C. upon transition from the HD process to the DR process in the HDDR operation is to prevent the crystal grains formed by the DR process from additional growth during this process. In the present example, the obtained lump of HDDR-treated raw material alloy was mechanically crushed into coarse powder with an equivalent circle diameter of 100 pmn or less using the Wonder Blender (manufactured by OSAKA CHEMICAL Co, Ltd.). Such coarse powder obtained by the crushing the lump is also regarded as the HDDR-treated raw material alloy in the present invention.

In the rare earth grain boundary penetration process, the coarsely crushed lump of HDDR-treated raw material alloy and the second alloy powder previously prepared by pulverizing the second alloy into powder having an average particle size of 4 μm by a jet mill method using nitrogen gas were mixed at the weight ratio of 95:5 and heated at a temperature of 700° C. for 10 minutes, to thereby prepare a lump of raw material alloy having a high rare-earth content.

In the raw material alloy powder preparation process, the lump of raw material alloy having a high rare-earth content was maintained in a hydrogen atmosphere at a temperature of 200° C. for five hours to embrittle the lump, and was subsequently pulverized into powder having an average particle size of 1 μm or less by a helium jet mill method, to thereby prepare raw material alloy powder.

In the orienting process, an organic lubricant was first mixed in the raw material alloy powder; the powder was placed in a mold at a filling density of 3.5 g/cm³; and a pulsed magnetic field of approximately 5 tesla was applied without conducting compression molding. In the subsequent sintering process, the raw material alloy powder being held in the mold was sintered by being heated in vacuum at a temperature of 940° C. for one hour without undergoing compression molding. After the sintering process, the obtained sintered body was heated for ten minutes in an argon atmosphere at the temperature at which the highest coercivity can be obtained within the range from 500° C. to 660° C. The obtained sintered body was machined to create a cylindrical RFeB system sintered magnet measuring 9.8 mm in diameter and 7.0 mm in length.

### Method for Producing RFeB System Sintered Magnet According to Example 2

In Example 2, an RFeB system sintered magnet was produced using, as materials, a lump of RFeB system alloy and powder of a second alloy having the compositions shown in Table 2 below by basically the same processes as used in Example 1. The differences from Example 1, other than the compositions of materials, are listed below.
The second alloy powder was prepared using the Wonder Blender instead of the jet mill method using nitrogen gas. Accordingly, the average particle size of the second alloy powder was larger than that of Example 1.
The mixture ratio of the lump of HDDR-treated raw material alloy with the second alloy powder in the rare earth grain boundary penetration process was 94:6 in weight ratio, and the heating time was 30 minutes (the heating temperature was 700° C., i.e. the same as in Example 1).
The sintering temperature in the sintering process was 860° C.

TABLE 2
Composition of materials used in Example 2 (unit: % by weight)

| | TRE | Nd | Pr | B | Cu | Al | Co | Fe |
|---|---|---|---|---|---|---|---|---|
| RFeB system | 27.6 | 27.47 | 0.07 | 1.10 | 0.00 | 0.04 | 0.00 | bal. |
| alloy lump | | | | | | | | |
| Second alloy | 80.0 | 80.0 | 0.00 | 0.00 | 10.0 | 10.0 | 0.00 | 0.00 |
| powder | | | | | | | | |

*The composition of the second alloy powder was the same as used in Example 1.

### Method for Producing RFeB System Sintered Magnet According to Examples 3 to 7

In Examples 3 to 7, as shown in Table 3 below, lumps of RFeB system alloy having the same composition (but different from those used in Examples 1 and 2) were used, and the second alloy powders having individual compositions were used. The composition of the second alloy powder in Example 3 was the same as used in Examples 1 and 2. The differences from Example 1 with respect to conditions other than the composition of the materials are listed below.
The mixture ratio of the lump of HDDR-treated raw material alloy with the second alloy powder in weight ratio in the rare earth grain boundary penetration process was 95:5, and the heating time was 60 minutes (the heating temperature was 700° C., i.e., the same as in Example 1).
The sintering temperature in the sintering process was 890° C. in Examples 3 and 4, and 880° C. in Examples 5 to 7.

TABLE 3
Composition of materials used in Examples 3 to 7 (unit: % by weight)

| | | TRE | Nd | Pr | B | Cu | Al | Co | Ga | Fe |
|---|---|---|---|---|---|---|---|---|---|---|
| RFeB | Common to | 2.75 | 27.4 | 0.1 | 1.13 | 0 | 0.04 | 0.01 | 0 | bal. |
| system | Examples 3 to 7 | | | | | | | | | |
| alloy | | | | | | | | | | |
| lump | | | | | | | | | | |
| Second | Example 3 | 80.0 | 80.0 | 0 | 0 | 10.0 | 10.0 | 0 | 0 | 0 |
| alloy | Example 4 | 76.05 | 76.05 | 0 | 1.03 | 9.50 | 9.50 | 0 | 0 | bal. |
| powder | Example 5 | 63.83 | 63.83 | 0 | 0 | 0.59 | 0 | 0 | 3.06 | bal. |
| | Example 6 | 90.07 | 90.07 | 0 | 0 | 2.02 | 0 | 0 | 6.35 | bal. |
| | Example 7 | 83.55 | 83.55 | 0 | 0 | 2.42 | 0 | 0 | 11.77 | bal. |

### Method for Producing RFeB System Sintered Magnet According to Comparative Examples

In Comparative Examples, RFeB system sintered magnets were produced using lumps of two types of RFeB system alloys having composition shown in Table 3 below, by the four steps as shown in FIG. 1B, including the HDDR process (Step S91), raw material alloy powder preparation process (Step S93), orienting process (Step S94), and sintering process (Step S95). In the HDDR process, the lump of RFeB system alloy was subjected to the same HDDR treatment as in Examples 1 and 2, to prepare a lump of HDDR-treated raw material alloy. Subsequently, the operation immediately proceeded to the raw material alloy powder preparation process, without conducting any processes corresponding to the rare earth grain boundary penetration process conducted in Examples 1 and 2. In the raw material alloy powder preparation process, the lump of HDDR-treated raw material alloy was held in a hydrogen atmosphere at a temperature of 200° C. for five hours to embrittle the lump, and subsequently pulverized into powder having an average particle size of 1 μm or less by the helium jet mill method, to thereby prepare raw material alloy powder. The raw material alloy powder thus obtained was subjected to the orienting process and the sintering process in a similar manner to Examples 1 and 2. Thus, RFeB system sintered magnets according to Comparative Examples were obtained.

TABLE 4
Composition of RFeB system alloy lump used in Comparative Examples
(unit: % by weight)

| | TRE | Nd | Pr | B | Cu | Al | Co | Fe |
|---|---|---|---|---|---|---|---|---|
| Comparative | 30.42 | 26.35 | 4.07 | 1.00 | 0.10 | 0.28 | 0.92 | bal. |
| Example 1 | | | | | | | | |
| Comparative | 32.59 | 28.23 | 4.36 | 1.00 | 0.10 | 0.26 | 0.96 | bal. |
| Example 2 | | | | | | | | |

### Composition of Raw Material Alloy Powder in Examples and Comparative Examples

Table 4 shows the results obtained by measuring the composition at the stage of raw material alloy powder (which is considered to have a composition close to that of the obtained RFeB system sintered magnet) in Examples 1 and 2 as well as Comparative Examples 1 and 2. As for the TRE value, both Examples and Comparative Examples have higher TRE values than those of the main phase, i.e., 26 to 27% by weight (when the rare-earth elements R are Nd and Pr). In other words, the content ratio of the rare-earth elements R in the entire raw material alloy powder is higher than that of the main phase.

TABLE 5
Composition of raw material alloy powder (unit: % by weight)

| | TRE | Nd | Pr | B | Cu | Al | Co | Fe |
|---|---|---|---|---|---|---|---|---|
| Example 1 | 30.61 | 27.00 | 3.61 | 0.94 | 0.49 | 0.54 | 0.88 | bal. |
| Example 2 | 31.16 | 31.10 | 0.06 | 0.99 | 0.64 | 0.61 | 0.00 | bal. |
| Comparative | 30.05 | 26.00 | 4.04 | 0.97 | 0.10 | 0.28 | 0.89 | bal. |
| Example 1 | | | | | | | | |
| Comparative | 32.65 | 28.20 | 4.44 | 0.95 | 0.11 | 0.28 | 0.94 | bal. |
| Example 2 | | | | | | | | |

### Coercivity of the RFeB System Sintered Magnets Obtained in Examples and Comparative Examples

The coercivity of the RFeB system sintered magnets obtained in Examples and Comparative Examples was measured. The results were as shown in Table 6 below. Saturation magnetization was also measured for Examples 3 to 7. As shown in Table 6, the coercivity in Examples is higher than those in Comparative Examples, although the sintered magnets were prepared under almost the same conditions in both Examples and Comparative Examples, except for the implementation of the rare earth grain boundary penetration process. The saturation magnetization in Examples 5 to 7 is higher than those of Examples 3 and 4. The coercivity in Examples 5 to 7 is as high as in other Examples. Examples 5 to 7 are the same as Examples 3 and 4 in terms of the composition of the lump of RFeB system alloy as well as the mixture ratio of the lump of RFeB system alloy with the second alloy powder, but different from Examples 3 and 4 in that the second alloy powder contains gallium (Ga). Thus, it is clarified that both high saturation magnetization and high coercivity can be achieved by additionally mixing Ga in the second alloy powder.

TABLE 6
Measured result of coercivity and saturation magnetization

| | Coercivity | Saturation |
|---|---|---|
| | (kOe) | magnetization (kG) |
| Example 1 | 15.5 | — |
| Example 2 | 16.4 | — |
| Example 3 | 15.65 | 14.36 |
| Example 4 | 15.59 | 14.44 |
| Example 5 | 14.87 | 15.31 |
| Example 6 | 15.97 | 14.87 |
| Example 7 | 16.08 | 14.82 |
| Comparative Example 1 | 11.5 | — |
| Comparative Example 2 | 12.7 | — |

For an RFeB system sintered magnet prepared by a normal method without the HDDR process, the higher the TRE value is, the larger the volume of the rare-earth rich phase becomes. This improves the dispersibility of the rare-earth rich phase, and thus an intergranular grain boundary with a large grain-boundary width is readily formed, thereby improving the coercivity. By comparison, the results of Comparative Examples demonstrate that, in the case of an RFeB system sintered magnet prepared with the HDDR process, the coercivity cannot be improved by merely increasing the TRE values. The reason is as follows. Even if the TRE value is increased, a lamellae structure of the rare-earth rich phase remains after the HDDR process. This prevents the rare-earth rich phase from penetrating through the main phase grains each of which is sandwiched between the rare-earth rich phases, resulting in an uneven structure.

### Electron Micrographs of Alloy Lumps Immediately Before Raw Material Alloy Powder Preparation Process in Example and Comparative Examples

Electron micrographs were taken for alloy lumps immediately before the raw material alloy powder preparation process in Example 2 and Comparative Examples 1 and 2, in order to ascertain reasons for the aforementioned difference in coercivity. The alloy lumps immediately before the raw material alloy powder preparation process are a lump of raw material alloy having a high rare-earth content in Example 2, and a lump of HDDR-treated raw material alloy in Comparative Examples 1 and 2. For Example 2, an electron micrograph was also taken for a lump of HDDR-treated raw material alloy.

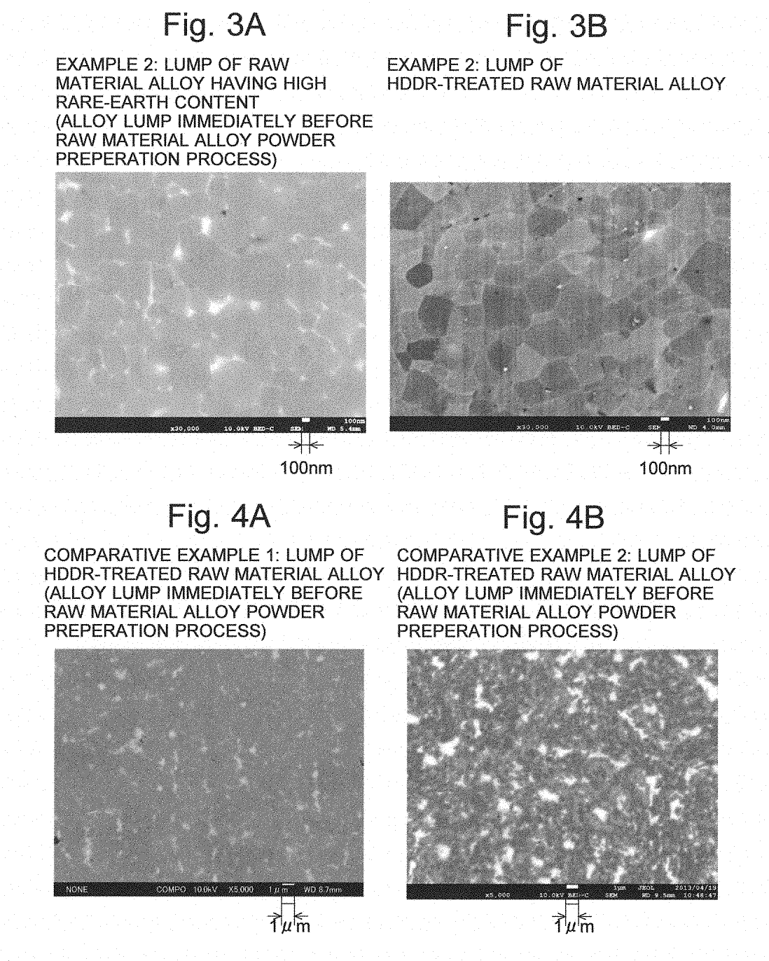

FIG. 3A is an electron micrograph showing a lump of raw material alloy having a high rare-earth content according to Example 2. FIG. 3B is an electron micrograph showing a lump of HDDR-treated raw material alloy according to Example 2. FIG. 4A is an electron micrograph showing a lump of HDDR-treated raw material alloy according to Comparative Example 1. FIG. 4B is an electron micrograph showing a lump of HDDR-treated raw material alloy according to Comparative Example 2. A comparison of the electron micrographs of alloy lumps immediately before the raw material alloy powder preparation process, i.e. a comparison of the electron micrograph of FIG. 3A with those of FIG. 4A and FIG. 4B, demonstrates that white line-like portions between the gray grains are clearly observed in FIG. 3A which shows Example 2, whereas white dot-like portions are observed within the widespread gray areas in FIGS. 4A and 4B which show the Comparative Examples. This means that, in Example 2, the rare-earth rich phase including the second alloy is uniformly spread through the grain boundaries of the crystal grains (gray grains) in the lump of raw material alloy having a high rare-earth content, whereas, in Comparative Examples, the rare-earth rich phase is not uniformly spread through the grain boundaries, but localized at dot-like portions. This shows that, in Example 2, the rare-earth rich phase is uniformly diffused among the grains in the raw material alloy powder obtained by pulverizing the lump of raw material alloy having a high rare-earth content, and thus the rare-earth rich phase was uniformly diffused among the crystal grains in the RFeB system sintered magnet obtained by sintering such raw material alloy powder, forming intergranular grain boundaries having a large grain-boundary width. In contrast, the raw material alloy powder obtained by pulverizing the lump of HDDR-treated raw material alloy according to the Comparative Examples does not allow the rare-earth rich phase to be uniformly diffused among the grains, which also prevents the RFeB system sintered magnet obtained by sintering such raw material alloy powder from having the rare-earth rich phase uniformly diffused among the crystal grains. This is the likely reason why intergranular grain boundaries having a large grain-boundary width cannot be formed.

The electron micrograph of FIG. 3B, which shows the lump of HDDR-treated raw material alloy according to Example 2, shows almost no white portion. This is due to the fact that the lump of HDDR-treated raw material alloy (and the same alloy lump in the previous stage) used in Example 2 had a TRE value close to that of the main phase, which means that the HDDR-treated raw material alloy includes almost no rare-earth rich phase. Performing the rare earth grain boundary penetration process on such a lump of HDDR-treated raw material alloy that contains little rare-earth rich phase results in a lump of raw material alloy that contains a high amount of rare earth, with the rare-earth rich phase diffused through the grain boundaries of the crystal grains, as shown in FIG. 3A.

1. A method for producing an RFeB system sintered magnet containing a rare-earth element R, Fe, and B as main components, the method comprising:
a) a process of preparing a lump of HDDR-treated raw material alloy that contains a polycrystalline substance including crystal grains having an average grain size of 1 μm or less in terms of an equivalent circle diameter calculated from an electron micrograph image, by an HDDR treatment including steps of heating a lump of RFeB system alloy containing 26.5 to 29.5% by weight of the rare-earth element R, in a hydrogen atmosphere at a temperature between 700 and 1,000° C., and changing the atmosphere to vacuum while maintaining the temperature within a range from 750 to 900° C.;
b) a process of preparing a lump of raw material alloy having a high rare-earth content by heating the lump of HDDR-treated raw material alloy at a temperature between 700 and 950° C. in a state where the HDDR-treated raw material alloy is in contact with a contact substance including a second alloy that contains the rare-earth element R at a higher content ratio than a content ratio of the rare-earth element R in the RFeB system alloy;
c) a process of preparing raw material alloy powder by fine pulverization of the lump of raw material alloy having a high rare-earth content into powder having an average particle size of 1 μm or less;
d) an orienting process including steps of placing the raw material alloy powder in a mold, and applying a magnetic field to the raw material alloy powder without conducting compression molding; and
e) a sintering process including a step of heating the oriented raw material alloy powder at a temperature between 850 and 1,050° C.

2. The method for producing an RFeB system sintered magnet according to claim 1, wherein the lump of RFeB system alloy is prepared by a strip casting method.

3. The method for producing an RFeB system sintered magnet according to claim 1, wherein the contact substance is in a powdery form.

4. The method for producing an RFeB system sintered magnet according to claim 1, wherein the fine pulverization is performed by a jet mill method using helium gas.

5. The method for producing an RFeB system sintered magnet according to claim 1, wherein the second alloy contains Ga.

6. The method for producing an RFeB system sintered magnet according to claim 2, wherein the contact substance is in a powdery form.

7. The method for producing an RFeB system sintered magnet according to claim 2, wherein the fine pulverization is performed by a jet mill method using helium gas.

8. The method for producing an RFeB system sintered magnet according to claim 3, wherein the fine pulverization is performed by a jet mill method using helium gas.

9. The method for producing an RFeB system sintered magnet according to claim 6, wherein the fine pulverization is performed by a jet mill method using helium gas.

10. The method for producing an RFeB system sintered magnet according to claim 2, wherein the second alloy contains Ga.

11. The method for producing an RFeB system sintered magnet according to claim 3, wherein the second alloy contains Ga.

12. The method for producing an RFeB system sintered magnet according to claim 4, wherein the second alloy contains Ga.

13. The method for producing an RFeB system sintered magnet according to claim 6, wherein the second alloy contains Ga.

14. The method for producing an RFeB system sintered magnet according to claim 7, wherein the second alloy contains Ga.

15. The method for producing an RFeB system sintered magnet according to claim 8, wherein the second alloy contains Ga.

16. The method for producing an RFeB system sintered magnet according to claim 9, wherein the second alloy contains Ga.
